(19) United States
(12) Patent Application Publication
(10) Pub. No.: US 2021/0049631 A1
(43) Pub. Date: Feb. 18, 2021

(54) SYSTEM AND METHOD FOR PRICE OPTIMIZATION FOR FASHION APPARELS RETURNED IN ONLINE RETAILING

(71) Applicant: Tata Consultancy Services Limited, Mumbai (IN)

(72) Inventors: JEISOBERS THIRUNAVUKKARASU, Chennai (IN); ARUN RASIKA KARUNAKARAN, Chennai (IN)

(73) Assignee: Tata Consultancy Services Limited, Mumbai (IN)

(21) Appl. No.: 16/986,514

(22) Filed: Aug. 6, 2020

(30) Foreign Application Priority Data
Aug. 14, 2019 (IN) 201921032894

(51) Int. Cl. G06Q 30/02; G06Q 10/08; G06N 20/00

(52) U.S. Cl. CPC G06Q 30/0206; G06N 20/00; G06Q 10/087; G06Q 30/0211

(57) ABSTRACT

This disclosure relates to a system and method to optimize price of products with varying length of life cycle that are returned in online retailing. Sets of information pertaining to a SKU group is collected and integrated at an individual transaction level. The integrated data is processed to create an attribute repository matrix followed by attribute component matrix. In addition, time interval between introductory date of fashion apparel and its date of transaction is noted for each transaction. Effect of price and attribute components on time interval are trained using machine-learning model. Length of life cycle is estimated at an attribute component level. Price of a return product is optimized based on effect of price, its attribute components and their length of life cycle, presence of promotion, presence of number of new attribute values, product cost, additional cost involved in returning process and time of return.

### CROSS-REFERENCE TO RELATED APPLICATIONS AND PRIORITY

This U.S. patent application claims priority under 35 U.S.C. § 119 to India Application No. 201921032894, filed on Aug. 14, 2019. The entire contents of the abovementioned application are incorporated herein by reference.

### TECHNICAL FIELD

The disclosure herein generally relates to a field of price optimization of a product and, more particularly, a system and method for a price optimization for fashion apparels that are returned in online retailing.

### BACKGROUND

In retail scenario, online retailing had significant growth in the past few years due to advent of digital innovations and globalizations. In response, shopper returns also had significant increase causing revenue leakage particularly for fashion apparel. However, retailers are not equipped to know the worthiness of returned fashion apparel at different point of time post launch of the product. Therefore, they face challenges in taking decision on products that are returned at particular point of time post launch of the product.

Value of the returned product varies based on the life cycle of the respective product. Based on its length of life cycle they are noted as fad or classic. A fad is a design that continues only one season or sometimes even less than a season. Bright colors, military styles, leather pants and paper dresses are few examples for fad. As they are short lived with limited historical data, they make the application of time series analysis for pricing more challenging. A classic fashion is a style that continues for longer duration. Simple black dress, white collared shirt, Jeans and running shoes are few examples for classic style. The life cycle of the product depends on the combined effect of attribute values. Individual attribute values will have different sales preference when it is combined with other attribute values. For example, a customer may prefer to buy a top with polka dot in black color and she may not prefer polka dot top in other color. There is variation of customer preference with respect to individual attribute values individually as compared to combine with other attribute values.

In addition, Fashion apparel usually constitute recently launched attribute values with no historical information, which also makes its usage for pricing as challenging. The cost associated with return products are transportation cost, warehouse cost, customer service cost, administration cost and materials cost. It is observed that the transportation and warehouse cost holds for more than eighty percent of total logistic cost. The magnitude of logistic cost also influences the optimal price of the return product

### SUMMARY

Embodiments of the present disclosure provides technological improvements as solutions to one or more of the abovementioned technical problems recognized by the inventors in conventional systems.

A processor-implemented method to optimize price of one or more products that are returned in online retailing. It would be appreciated that the present disclosure considers the products having life cycle with varying lengths. Distinct values of the attribute values are extracted from all the apparels within a Stock Keeping Unit (SKU) group and they form column of attribute repository matrix. If one SKU group has ‘n’ distinct attribute values, and then the column of attribute repository matrix takes the name as AV_1, AV_2, AV_3 . . . AV_n. Each transaction form the row of attribute repository matrix and rows are added based on addition of transactions occurring in the SKU group. The SKU group comprises one or more products that are having similar buying preferences or having attribute values that are alternative to each other. A category could form the SKU group. Example for SKU group are women's tops, women's suits, men's shirts and men's suits, etc.

The method comprises one or more steps as collecting one or more sets of information pertaining to a predefined SKU group from one or more predefined sources. The collected one or more sets of information is integrated at an individual transaction level. The integrated data is processed to create an attribute repository matrix with one or more attribute values of each of the products within the predefined SKU group and to derive attribute component matrix to realize underlying relationship occurring across attribute values at the time of purchase of one or more products. A mutual column is created for capturing the effect of new attribute value(s) on the time interval pattern. Further, the method comprises data analysis effect of price, one or more attribute components, promotion and number of new attribute values on the time interval pattern using machine-learning methods and learning life cycle pattern associated with one or more attribute components. Finally optimizing the price of each of the one or more products of the predefined SKU group at different point of time post launch based on the analyzed effect of price, one or more attribute components, its length of life cycle, presence of promotion, presence of number of new attribute values, product cost and additional cost associated with logistics of each of the one or more products.

In another embodiment, a system is configured to optimize price of one or more products that are returned in online retailing. The system comprising at least one memory storing a plurality of instructions and one or more hardware processors communicatively coupled with at least one memory. The one or more hardware processors are configured to execute one or more modules comprises of a data collection module, a data integration module, a data processing module, a data analysis module and a price optimization module.

The data collection module of the system is configured to collect one or more sets of information pertaining to a predefined Stock Keeping Unit (SKU) group from one or more predefined sources. The data integration module is configured to integrate the collected one or more sets of information of the predefined SKU group, wherein the collected information is integrated at an individual transaction level. The data processing module is configured to process the integrated data to create an attribute repository matrix with one or more attribute values of each of the products within the predefined SKU group and to derive attribute component matrix to realize underlying relationship occurring across attribute values at the time of purchase of one or more products. The data analysis module is configured to analyze effect of price, one or more attribute components, presence of promotion and presence of number of new attribute values on the time interval pattern using machine-learning methods and to learn life cycle pattern associated with one or more attribute components. The price optimization module configured to optimize price of each of the one or more products of the predefined SKU group at different point of time post launch based on the analyzed effect of price, one or more attribute components, its length of life cycle, presence of promotion, presence of number of new attribute values, product cost and additional cost associated with logistics of each of the one or more products.

In yet another embodiment, a non-transitory computer readable medium storing one or more instructions which when executed by a processor on a system, cause the processor to perform method comprising collecting one or more sets of information pertaining to a predefined SKU group from one or more predefined sources. The collected one or more sets of information is integrated at an individual transaction level. The integrated data is processed to create an attribute repository matrix with one or more attribute values of each of the products within the predefined SKU group and to derive attribute component matrix to realize underlying relationship occurring across attribute values at the time of purchase of one or more products. A mutual column is created for capturing the effect of new attribute value(s) on the time interval pattern. Further, the method comprises data analysis effect of price, one or more attribute components, promotion and number of new attribute values on the time interval pattern using machine-learning methods and learning life cycle pattern associated with one or more attribute components. Finally optimizing the price of each of the one or more products of the predefined SKU group at different point of time post launch based on the analyzed effect of price, one or more attribute components, its length of life cycle, presence of promotion, presence of number of new attribute values, product cost and additional cost associated with logistics of each of the one or more products.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates a system for price optimization for products that are returned in online retailing, in accordance with some embodiments of the present disclosure.

FIG. 2 is a functional block diagram for price optimization for products that are returned in online retailing, in accordance with some embodiments of the present disclosure.

FIG. 3 is a flow diagram to illustrate a method for price optimization for products that are returned in online retailing, in accordance with some embodiments of the present disclosure.

It should be appreciated by those skilled in the art that any block diagrams herein represent conceptual views of illustrative systems and devices embodying the principles of the present subject matter. Similarly, it will be appreciated that any flow charts, flow diagrams, and the like represent various processes, which may be substantially represented in computer readable medium and so executed by a computer or processor, whether or not such computer or processor is explicitly shown.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The embodiments herein provide a method and a system for price optimization for one or more product that are returned in online retailing. Wherein the one or more products are short lived with limited historical data, which makes the application of time series analysis for pricing more challenging. In addition, one or more products usually constitute recently launched attribute(s) values with no historical information, which makes its usage for pricing as challenging. Moreover, it is to be noted that the cost associated with return products are transportation cost, warehouse cost, customer service cost, administrative cost and material cost. Transportation and warehouse cost holds for roughly eighty percent of total additional cost associated with return products. Therefore, by considering varying life cycle length of attribute components and logistic cost associated with return products, the price of return product is optimized.

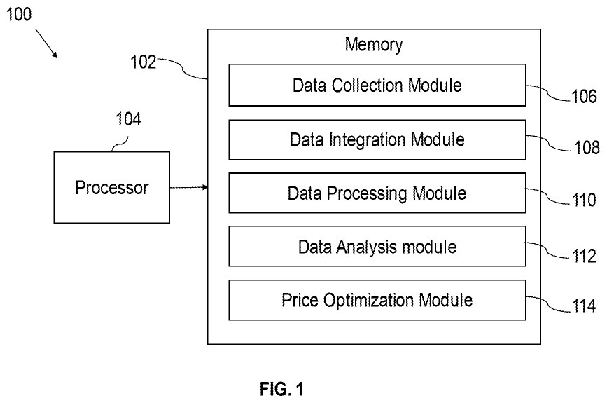

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 illustrates a system (100) for price optimization for one or more product that are returned in online retailing. Wherein information pertaining to online transactions, cost associated with the logistics and price of the one or more products are collected and processed to recommend an optimal price of each product. In the preferred embodiment, the system (100) comprises at least one memory (102) with a plurality of instructions and one or more hardware processors (104) which are communicatively coupled with the at least one memory (102) to execute modules therein.

The hardware processor (104) may be implemented as one or more microprocessors, microcomputers, microcontrollers, digital signal processors, central processing units, state machines, logic circuitries, and/or any devices that manipulate signals based on operational instructions. Among other capabilities, the hardware processor (104) is configured to fetch and execute computer-readable instructions stored in the memory (102). Further, the system comprises a data collection module (106), a data integration module (108), a data processing module (110), a data analysis module (112), and a price optimization module (114).

In the preferred embodiment of the disclosure, the data collection module (106) of the system (100) collects one or more sets of information pertaining to the SKU group from one or more predefined sources. The predefined SKU group comprises one or more products that are having similar buying nature.

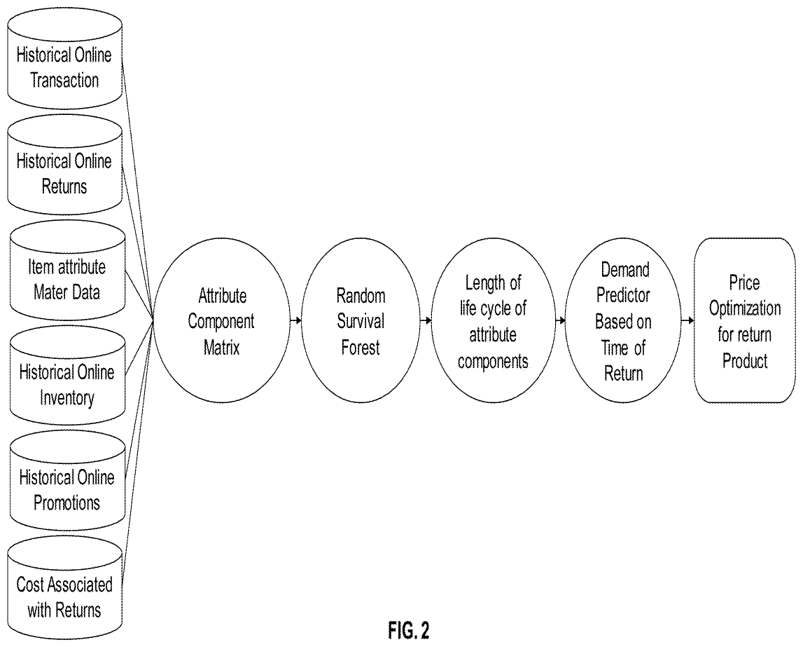

In one example, online transaction data that are related to fashion apparel are extracted from point of sale (POS) systems. The POS contains price of the apparel and time of transaction. Further, an apparel master data have attribute details of the apparel and introductory date of the apparel. Return database have the logistic cost involved during the return process as shown in FIG. 2.

In the preferred embodiment of the disclosure, the data integration module (108) of the system (100) is configured to integrate the collected one or more sets of information of the predefined SKU group, wherein the collected information is integrated at an individual transaction level. Fashion apparels that come under one SKU group are considered at one time for capturing the effect of attributes on the sales of apparel. The SKU group, which is associated with the apparel that was returned by a customer, is considered at a time.

In the preferred embodiment of the disclosure, the data processing module (110) of the system (100) is configured to generate a data matrix of the processed information to process the integrated data to create an attribute repository matrix with one or more attribute values of each of the products within the predefined SKU group and to derive attribute component matrix to realize underlying relationship occurring across attribute values at the time of purchase of one or more products.

It would be appreciated that the distinct values of one or more attribute values are extracted from all the apparels within the SKU group and they form the column of the attribute repository matrix. Each transaction within the SKU group form the row of attribute repository matrix and rows are added based on addition of transactions occurring in the SKU group. Each cell of the attribute repository matrix is filled with 1 or 0 based on presence or absence of each of the one or more attribute values of apparel bought during the transaction.

Herein, the attribute repository matrix is applied with data reduction technique namely principal component analysis and top significant attribute components are extracted and they form an attribute component matrix. The number of attribute components is decided by the nature of relationship that occur between attribute values. In practical situations, attribute components have more meaningful information than attribute values and they are capable of capturing interaction effects that happen across attribute values while purchasing an apparel.

In one example, wherein a customer has preference with off-shoulder in combination with flair sleeve while selecting women's top and she may not buy if they are not available in combinations. Similarly, one or more attribute values have different sales preference when they are considered individually as compared to combined. The hidden relationship between attribute values is captured in the form of attribute components. Each attribute component can be considered as group of attribute values that are related in making buying decisions. These components are noted as ‘A_Comp_1’, ‘A_Comp_2’, ‘A_Comp_m’. The attribute Component matrix has same number of rows similar to the attribute repository matrix. However, the number of columns are reduced as compared to the attribute repository matrix and are decided by the outcome of principal component analysis dynamically. Each cell of the attribute component matrix is filled by component score, which is an outcome of principal component analysis.

It would be appreciated that whenever, a new apparel is introduced in the market with new attribute value, an additional column is created in the attribute repository matrix and it is noted under mutual column. These mutual columns are filled with 1 or 0 based on the presence or absence of new attribute value present in the fashion apparel respectively.

Further, the time duration between introductory date of the fashion apparel and date of transaction is calculated and it is noted under column namely “time interval”. The time interval is calculated for each transaction. In addition, one more column namely “censor variable” is created to denote products continuity. It would be appreciated that the one or more products, which are discontinued are noted as ‘0’ and others are noted as ‘1’ against “censor variable”. Return date of fashion apparel is considered as cut of date to decide continuity and discontinuity. The two columns namely “time interval” and “censor variable” are filled against each transaction.

It is to be noted that the time interval of each transaction along with a censor variable act as target or dependent variable and attribute component matrix along with mutual column, price of the apparel and promotion indicator act as independent variables. It is assumed that the time interval is depending on price of the apparel, attribute components, presence of promotion and presence of number of new attribute values. A machine-learning model such as random survival forest is applied to learn the effect of price, attribute components, presence of promotion and presence of number of new attribute values on the time interval pattern. In one example, an open source software namely R software has package called Random Forest SRC. This package has provision to run Random Survival Forest. Random Survival Forest is an extension of Random Forest to analyze right censored, time to event data. The learning process of the machine-learning model is carried out by using latest historical data.

In the preferred embodiment of the disclosure, the data analysis module (112) of the system (100) is configured to analyze effect of price, the one or more attribute components, presence of promotion and presence of number of new attribute values on the time interval pattern using machine learning methods. The data analysis is done to learn life cycle pattern associated with one or more attribute components and to estimate length of lifecycle for each attribute components. It would be appreciated that the data analysis module (112) is enabled by the one or more attribute components to estimate the sales impact due to any new attribute value and it overcomes the lack of historical data for that particular attribute value.

Further, the data analysis module (112) of the system (100) generates a row of attribute component matrix having defined cell values. For example, it creates a row having maximum of ‘A_Comp_1’ against the column namely ‘A_Comp_1’ and ‘0’ for other columns except price of the apparel, which is kept as average price value. Maximum of ‘A_Comp_1’ is found from the component score of attribute component matrix under column of ‘A_Comp_1’ The simulated row is passed into machine learning models trained with latest historical data and expected sales units is predicted for a predefined time point. The predefined time point is an assumed duration from the introductory date of the product. The prediction process is repeated for many predefined time points. The number of time points will vary and is decided dynamically based on the distribution of expected sales units across different time points. The distribution of expected sales against time point is derived. The time point corresponding to 5^{th} percentile of the distribution is considered as min time point and 95^{th} percentile is considered as max time point. The interval between the maximum time point and minimum time point provides the length of life cycle of an attribute component.

The same procedure is repeated for all significant attribute components. Therefore, if there are ‘n’ attribute components within a SKU group then it will provide ‘n’ length of life cycle and it is standardized to unit scale. Herein, each attribute component will have a magnitude of 0 to 1. The attribute component having magnitude near to 0 will have shorter length of life cycle and the attribute component having magnitude near to 1 will have longer length of life cycle. The magnitude variation is considered while prediction of sales for returned products. For example, if an attribute component ‘A_Comp_2’ has the length of life cycle value of ‘0.9’, the attribute component indicates that it has longer life cycle and if another component ‘A_Comp_4’ has the length of life cycle of ‘0.3’ it indicates that it has shorter life cycle and respective magnitude of values are used as weights while predicting the sales. The one or more attribute components enable to provide different weights while predicting the sales of the apparel for different price points and the weights are in proportion to the length of life cycle. This process ensures that the effect of short lived attribute components and long lived attribute components are considered while estimating the sales of a product for a given price point at a particular point of time.

In the preferred embodiment of the disclosure, the price optimization module (114) of the system (100) is configured to optimize price of each of the one or more products of the predefined SKU group at different point of time post launch based on the analyzed effect of price, one or more attribute components, its length of life cycle, presence of promotion, presence of number of new attribute values, product cost and additional cost associated with logistics of each of the one or more products.

In another aspect, wherein the expected sales units of a retuned fashion apparel is estimated for different prices by considering time lapse between introductory date and return date, length of life cycle of one or more attribute components of the apparel. Further, the expected profit is calculated from the expected sales units and profit per unit. Herein, the profit per unit is calculated by considering product price, product cost and additional cost associated with product return. The additional cost consists of transportation cost, warehouse cost, customer service cost, administration cost and materials cost. These costs are derived from the system of Distribution Centre or Centralized Return Centre. With the help of expected profit for different price point at return date, ideal price is found by maximizing profit using optimization function.

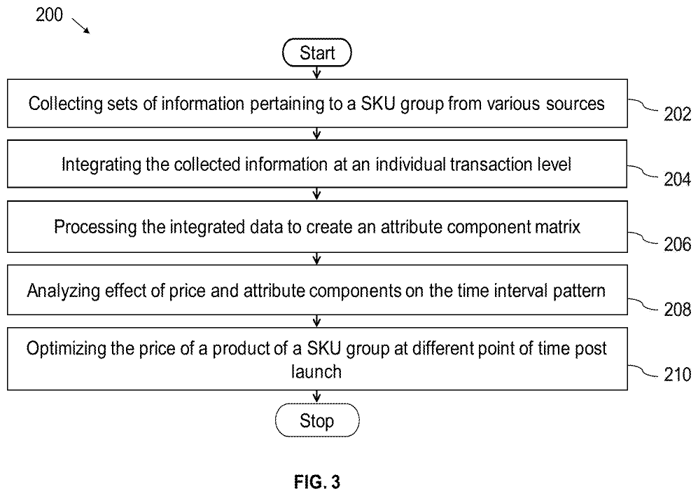

Referring FIG. 3, a processor-implemented method (200) price optimization for one or more product that are returned in online retailing. The method comprises one or more steps as follows.

Initially, at the step (202), one or more sets of information pertaining to a predefined Stock Keeping Unit (SKU) group are collected at a data collection module (106) of the system (100) from one or more sources. Wherein the one or more sets of information comprises online transaction data, master data, promotion information, historical information of returns, inventory, information pertaining to product cost and additional cost associated with returning of products within a predefined SKU group.

In the preferred embodiment of the disclosure, at the next step (204), the collected one or more sets of information of the predefined SKU group is integrated at a data integration module (108) of the system (100). It would be appreciated that the collected information is integrated at an individual transaction level.

In the preferred embodiment of the disclosure, at the next step (206), processing the integrated data at a data processing module (110) of the system (100) to create an attribute repository matrix with one or more attribute values of each of the products within the predefined SKU group. The data processing helps in deriving an attribute component matrix to realize underlying relationship occurring across attribute values at the time of purchase of fashion apparels.

In the preferred embodiment of the disclosure, at the next step (208), analyzing effect of price, one or more attribute components, presence of promotion and presence of number of new attribute values on the time interval pattern at a data analysis module (112) of the system (100) using machine-learning methods and learning life cycle pattern associated with one or more attribute components.

In the preferred embodiment of the disclosure, at the last step (210), optimizing price of each of the one or more products of the predefined SKU group at a price optimization module (114) of the system (100) at different point of time post launch based on the analyzed effect of price, one or more attribute components, its length of life cycle, presence of promotion, presence of number of new attribute values, product cost and additional cost associated with logistics of each of the one or more products.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device, which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development would change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A system (100) comprising:
at least one memory (102) storing a plurality of instructions;
one or more hardware processors (104) communicatively coupled with at least one memory (102), wherein the one or more hardware processors (104) are configured to execute one or more modules;
a data collection module (106) configured to collect one or more sets of information pertaining to a predefined Stock Keeping Unit (SKU) group from one or more predefined sources, wherein the predefined SKU group comprises one or more products having similar buying nature;
a data integration module (108) configured to integrate the collected one or more sets of information of the predefined SKU group, wherein the collected information is integrated at an individual transaction level;
a data processing module (110) configured to process the integrated data to create an attribute repository matrix with one or more attribute values of each of the products within the predefined SKU group, wherein the data processing helps in deriving an attribute component matrix to realize underlying relationship between one or more attribute values at the time of purchase of one or more products;
a data analysis module (112) configured to analyze an effect of price, the one or more attribute components, presence of promotion and presence of number of new attribute values on a time interval pattern using a machine learning method, wherein the data analysis is carried to learn a life cycle pattern associated with the one or more attribute components and to estimate a/the length of lifecycle for each attribute components; and
a price optimization module (114) configured to optimize a price of each of the one or more products of the predefined SKU group at a different point of time post launch based on the analyzed effect of price, one or more attribute components, length of life cycle of one or more product, presence of promotion, presence of number of new attribute values, product cost and additional cost associated with logistics of each of the one or more products.

2. The system (100) of claim 1, wherein the one or more sets of information comprises online transaction data, a master data, promotion information, historical information of returns, inventory and information pertaining to product cost and additional cost associated with returning of products within a predefined SKU group.

3. The system (100) of claim 2, wherein the master data of the product comprises one or more attributes of the product, and an introductory date of the product.

4. The system (100) of claim 1, wherein the predefined SKU group is considered at one time for capturing the effect of one or more attribute components on the time interval pattern.

5. The system (100) of claim 1, wherein the attribute repository matrix is created from the one or more attribute values extracted from the products within the predefined SKU group.

6. A processor-implemented method (200) comprising:
collecting (202), via one or more hardware processors, one or more sets of information pertaining to a predefined Stock Keeping Unit (SKU) group from one or more predefined sources, wherein the predefined SKU group comprises one or more products that are having similar buying nature;
integrating (204), via one or more hardware processors, the collected one or more sets of information of the predefined SKU group at each of the one or more individual transaction level;
processing (206), via one or more hardware processors, the integrated data to create an attribute repository matrix with one or more attribute values of each of the products within the predefined SKU group, wherein the data processing helps in deriving an attribute component matrix to realize underlying relationship occurring across attribute values at the time of purchase of the one or more products;
analyzing (208), via one or more hardware processors, effect of price, one or more attribute components, presence of promotion and presence of number of new attribute values on the time interval pattern using machine learning methods;
wherein the data analysis helps in learning life cycle pattern associated with one or more attribute components and estimating the length of life cycle for each attribute component; and
optimizing (210), via one or more hardware processors, the price of each of the one or more products of the predefined SKU group at different point of time post launch based on the analyzed effect of price, one or more attribute components, length of life cycle of the one or more products, presence of promotion, presence of number of new attribute values, product cost and additional cost associated with logistics of each of the one or more products.

7. The method (200) of claim 6, wherein the one or more sets of information comprises online transaction data, master data, promotion information, historical information of returns, inventory and information pertaining to product cost and additional cost associated with returning of products within a predefined SKU group.

8. The method (200) of claim 7, wherein the master data of the product comprises one or more attributes of the product, and introductory date of the product.

9. The method (200) of claim 6, wherein the predefined SKU group is considered at one time for capturing the effect of set of attribute components on the time interval pattern.

10. The method (200) of claim 6, wherein the attribute repository matrix is created from the attribute values extracted from the products within the predefined SKU group.

11. A non-transitory computer readable medium storing one or more instructions which when executed by a processor on a system, cause the processor to perform method comprising:
collecting, via one or more hardware processors, one or more sets of information pertaining to a predefined Stock Keeping Unit (SKU) group from one or more predefined sources, wherein the predefined SKU group comprises one or more products that are having similar buying nature;
integrating, via one or more hardware processors, the collected one or more sets of information of the predefined SKU group at each of the one or more individual transaction level;
processing, via one or more hardware processors, the integrated data to create an attribute repository matrix with one or more attribute values of each of the products within the predefined SKU group, wherein the data processing helps in deriving an attribute component matrix to realize underlying relationship occurring across attribute values at the time of purchase of the one or more products;
analyzing, via one or more hardware processors, effect of price, one or more attribute components, presence of promotion and presence of number of new attribute values on the time interval pattern using machine learning methods;
wherein the data analysis helps in learning life cycle pattern associated with one or more attribute components and estimating the length of life cycle for each attribute component; and
optimizing, via one or more hardware processors, the price of each of the one or more products of the predefined SKU group at different point of time post launch based on the analyzed effect of price, one or more attribute components, length of life cycle of the one or more products, presence of promotion, presence of number of new attribute values, product cost and additional cost associated with logistics of each of the one or more products.
